(19) United States
(12) Patent Application Publication
(10) Pub. No.: US 2004/0165013 A1
(43) Pub. Date: Aug. 26, 2004

(54) Cascading menu with automatic cursor relocation

(75) Inventors: Brian David Nelson, Austin, TX (US); Michael William Panico, Austin, TX (US); Hypatia Rojas, Round Rock, TX (US)

Correspondence Address: Mark D. Simpson, Synnestvedt & Lechner LLP, 2600 Aramark Tower, 1101 Market Street, Philadelphia, PA, 19107-2950, US

(73) Assignee: International Business Machines Corp., Armonk, NY

(21) Appl. No.: 10/371,038

(22) Filed: Feb. 20, 2003

(51) Int. Cl. G09G 5/00

(52) U.S. Cl. 345/858

(57) ABSTRACT

A GUI is configured to automatically shift the position of mouse pointer, upon activation of a menu selection that invokes a cascading child menu, to a location on or adjacent to the invoked child menu. This minimizes the need to move the mouse pointer horizontally to access a cascading menu and thus reduces the inadvertent selection of an incorrect menu item.

### FIELD OF THE INVENTION

This invention relates to personal computer systems and, more particularly, to a method, system, and computer program product for improving a graphical user interface (GUI) on a personal computer system and the use thereof.

### BACKGROUND OF THE INVENTION

In recent years, virtually all personal computers and workstation systems have adopted a graphical user interface (GUI) environment, which allows a user to manage the system and execute applications using a “point-and-click” method on objects shown on the computer display. The main GUI background is commonly referred to as the “desktop”, and the objects typically displayed on the desktop include graphic icons, which represent some software application or function, and windows, which divide the desktop into different areas on the display for different applications.

It is well known that with GUI systems, the computer system can be controlled using a pointing device such as a mouse. The pointing device controls the location of a pointer that appears on the screen of the computer's display device. Icons and windows may be manipulated using the mouse. In this way, underlying devices that the elements represent may be controlled.

Typical GUI systems employ “dropdown” menus to give the user of the GUI additional control and functionality options. For example, when a dropdown menu appears in the user's desktop on the screen, the user is presented with a first dropdown menu that typically includes a plurality of choices, each of the choices representing a basic function. FIG. 1 illustrates a typical dropdown menu structure found in most GUI's in use today. In FIG. 1, a dropdown menu 104 is displayed upon selection of the “Help” menu item 102 along the top of the window 100. Dropdown menu 104 in this example has several options for selection, including “tutorials” option 106, which includes a right arrow 108 next to the “tutorials” option 106.

The right arrow 108 is an indication that a sub-menu is available for the “tutorials” option 106, meaning that additional options exist under the heading “tutorials”. This is an example of what is known as a “cascading” dropdown menu, described below in connection with FIG. 2, and a menu item that will invoke a cascading menu (such as the menu item “tutorials”) are called “cascading menu items.”.

FIG. 2 illustrates the dropdown menu 104 of FIG. 1 after a user has clicked on the “tutorial” option 106. A mouse pointer 209 is shown on the left side of dropdown menu 104, designating the tutorials option 106 in a well-known manner. The location of the mouse when the user clicks on (designates) a menu item is referred to herein as the “designation point.” As can be seen in FIG. 2, a second dropdown menu 210 has been invoked, giving the user several choices under the “tutorials” category. The dropdown menu 210 is a cascading dropdown menu since it derives or cascades from dropdown menu 104. To select one of the tutorials displayed in cascading dropdown menu 210, the user must move the mouse pointer 209 from the designation point horizontally to the right, to cover one of the tutorial selections in cascading dropdown menu 210, and then click on the desired selection. As is well known, typically a user may place the mouse pointer anywhere along the black area (the “designation area”) around the tutorial option 106 to invoke the cascading menu 210, that is, the designation point must be somewhere within the designation area, determined at the moment that the user clicks the mouse in the designation area. The further away the mouse pointer is from the cascading menu when it is invoked, the further the distance will be to move the mouse pointer to the cascading menu to make a selection therefrom.

For the purpose of the discussion of cascading menus herein, it is important to identify the relationship between a menu generating (invoking) a cascade dropdown menu and the invoked cascading dropdown menu itself. For ease of explanation, the menus are described in term so of generations, so that a “parent” menu describes a first level of menu, which spawns or invokes a “child” menu, which in turn spawns or invokes a “grandchild” menu (relative to the parent), etc.

As shown in FIG. 2, a child menu in a prior art cascading menu system displays either to the right (typical as shown) or, if space is limited on the right side, to the left of the parent menu. In either case, there is essentially no overlap of the parent menu by its child menu. In other words, the child menu is “100% offset” with respect to its parent.

With the designation point of the mouse pointer located to the far left as shown, and a 100% offset as shown, the user is required to move the mouse pointer a significant distance in the horizontal direction (i.e., the entire width of the parent menu) just to reach the menu selections in the child menu. If there is more than one child menu available for the parent (i.e., if there are multiple cascading menu items in the parent menu), many times this results in the user inadvertently selecting the wrong child menu; as the user moves the mouse pointer horizontally, it travels upwards or downwards (i.e., it does not travel in a straight line horizontally across the screen) as it traverses the horizontal distance. Alternatively, even if only one child menu is available (e.g., as shown in FIG. 2) upward or downward travel of the pointer as it is moved towards the child menu may cause the child menu to disappear. This happens because the child menu is displayed only as long as the mouse pointer is hovering over the menu item in the parent menu that will spawn the child. These problems can be particularly acute when the user has a handicap affecting manual dexterity because, for example, their hands may shake as they move the mouse.

Accordingly, it would be desirable to have a cascading menu system in which the need to move the mouse pointer horizontally to reach a cascading menu is reduced and/or minimized.

### SUMMARY OF THE INVENTION

In accordance with the present invention, a GUI is configured to automatically shift the position of mouse pointer, upon activation of a cascading menu item that will spawn a child menu, to a location on or adjacent to the spawned child menu. This minimizes the need to move the mouse pointer horizontally to access a cascading menu and thus reduces the inadvertent selection of an incorrect menu item.

### BRIEF DESCRIPTION OF THE DRAWINGS

FIG. 1 illustrates a typical dropdown menu structure of a typical GUI;

FIG. 2 illustrates the dropdown menu of FIG. 1 after a user has clicked on a cascading menu item;

FIG. 3 illustrates the position of a mouse cursor, in accordance with the present invention, immediately after activation of a cascading menu item; and

FIG. 4 is a flowchart illustrating an example of steps performed by a GUI configured in accordance with the present invention.

### DETAILED DESCRIPTION OF THE INVENTION

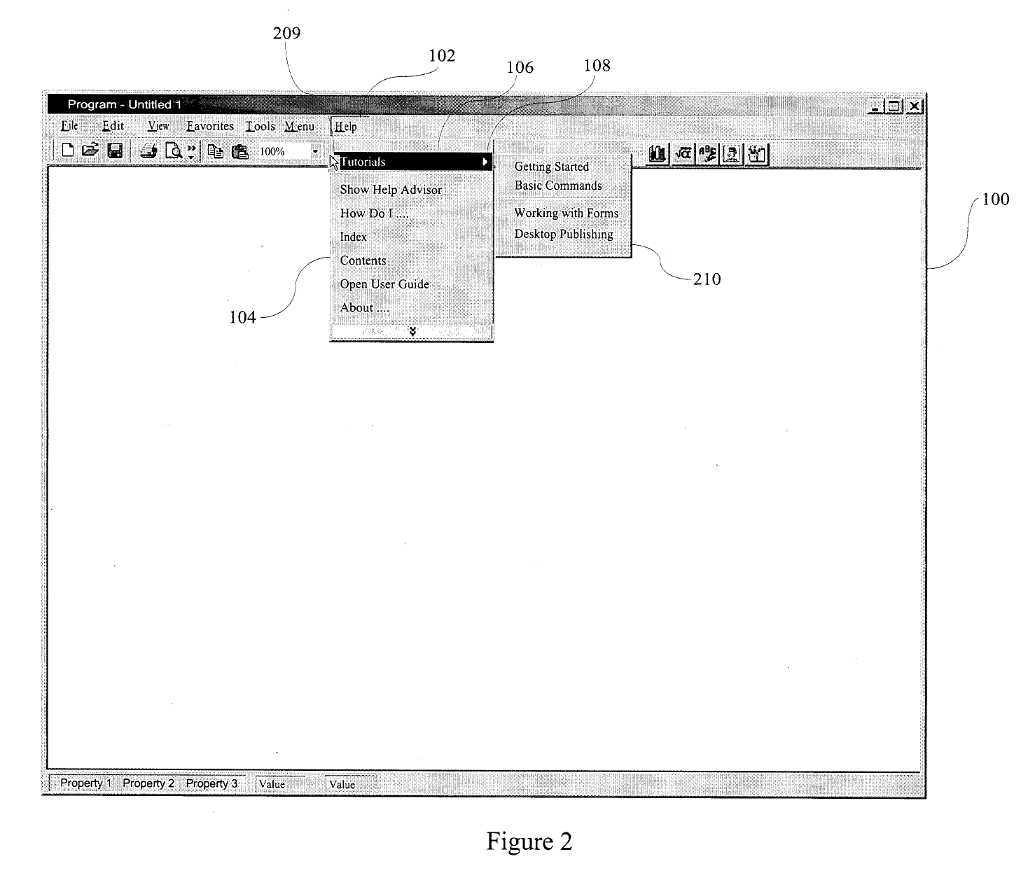

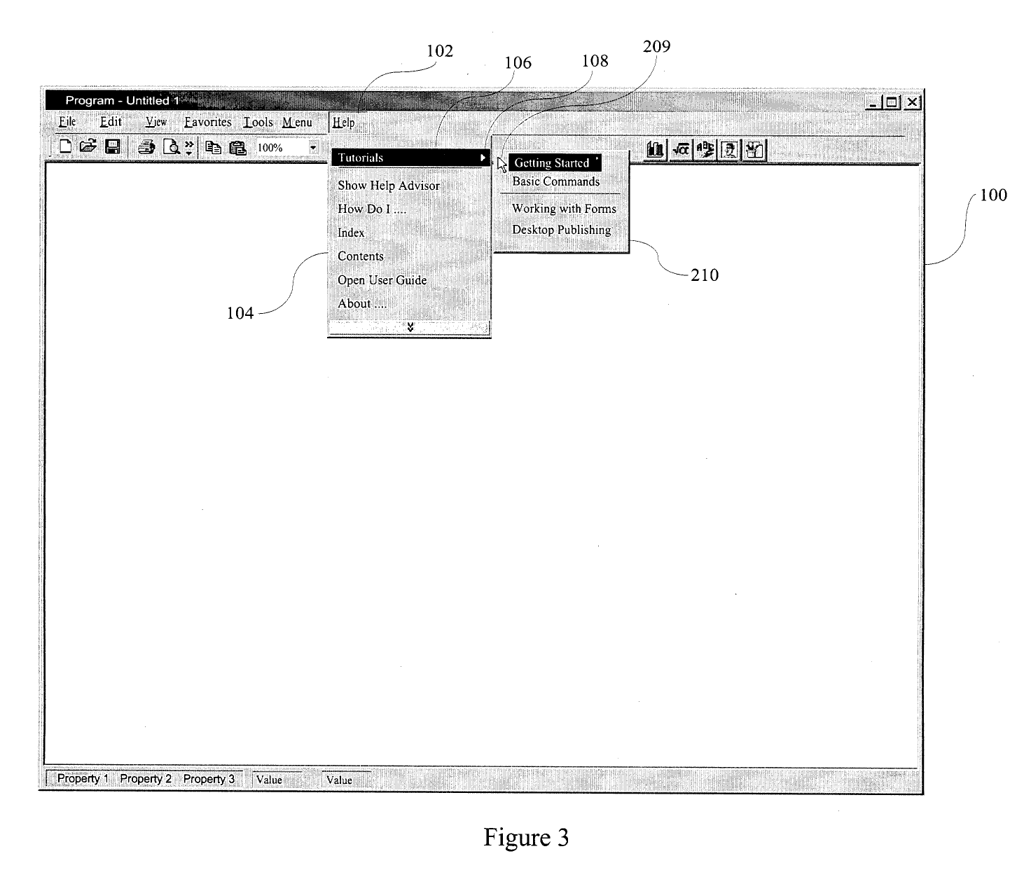

FIG. 3 illustrates the position of a mouse cursor immediately after activation of a cascading menu item on a parent menu that invokes a child menu, in accordance with the present invention. Referring to FIG. 3, child menu 210 is shown adjacent to the parent menu 104 from which it depends, just as in FIG. 2. In FIG. 3, however, the mouse pointer has automatically moved to be positioned on the left side of the child menu 210. No action is required by the user to move the pointer, other than selecting the cascading menu item from parent menu 104 that invokes child menu 210. This reduces significantly the amount of travel required of the mouse pointer to designate an item from the child menu.

The mouse pointer is configured to always be “on top”, i.e., it will always appear on the top layer of the GUI windows. Thus, when the user places the pointer on a cascading menu item (e.g., “tutorials”) in a parent menu and clicks the mouse to activate the cascading menu, the child menu will appear as in the prior art, but with the mouse pointer sitting directly on the child menu (or such other position as is dictated by the configuration of the GUI).

The precise positioning of the moved mouse cursor can be variable and selectable by the user according to their preference and/or needs, if desired. For example, rather than moving to the left side of the child menu, it could move instead to the left of the child menu itself (i.e., on the parent menu but directly adjacent to the child menu), or to the center or right side of the child menu, or any other desired location.

The location of the mouse pointer can be pre-designated or can be selectable by the user. The selection of the position can be performed using any known method for enabling a GUI user to select preferences for operation of the browser. For example, the user may be presented with a “preferences” option from a dropdown menu (e.g., from the “Tools” menu item along the top of window 100), which preference menu includes an option for selection of the automatic cursor location for cascading menus. The user can be given a selection menu from which preset values (e.g., top left, top right, top center, etc.) can be selected. Alternatively, the user may be presented with a dialogue box that allows the user to input a desired location via keyboard input. The method of selection is not considered novel; it is the automatic movement of the cursor and the ability to set the position of the moved cursor that is among the novel aspects of the present invention.

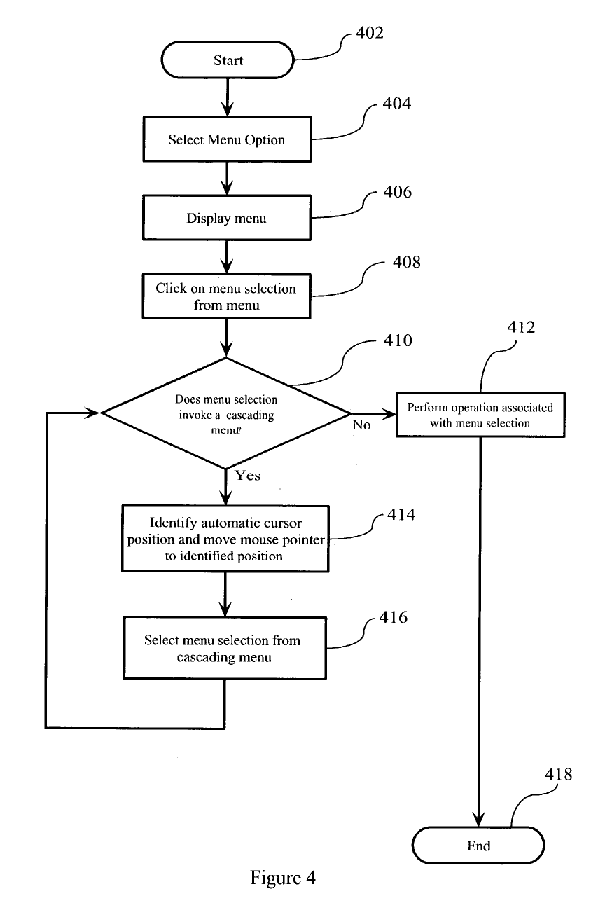

FIG. 4 is a flowchart illustrating an example of steps performed by a GUI configured in accordance with the present invention. At step 402, the GUI is started, and at step 404, the user selects a menu item. For example, the user may select the “Help” menu item 102 illustrated in, for example, FIG. 3. At step 406, as a result of the selection of the menu item, the GUI displays the parent menu in dropdown form as is well known. At step 408, the user uses the mouse to select a menu selection from the displayed parent menu.

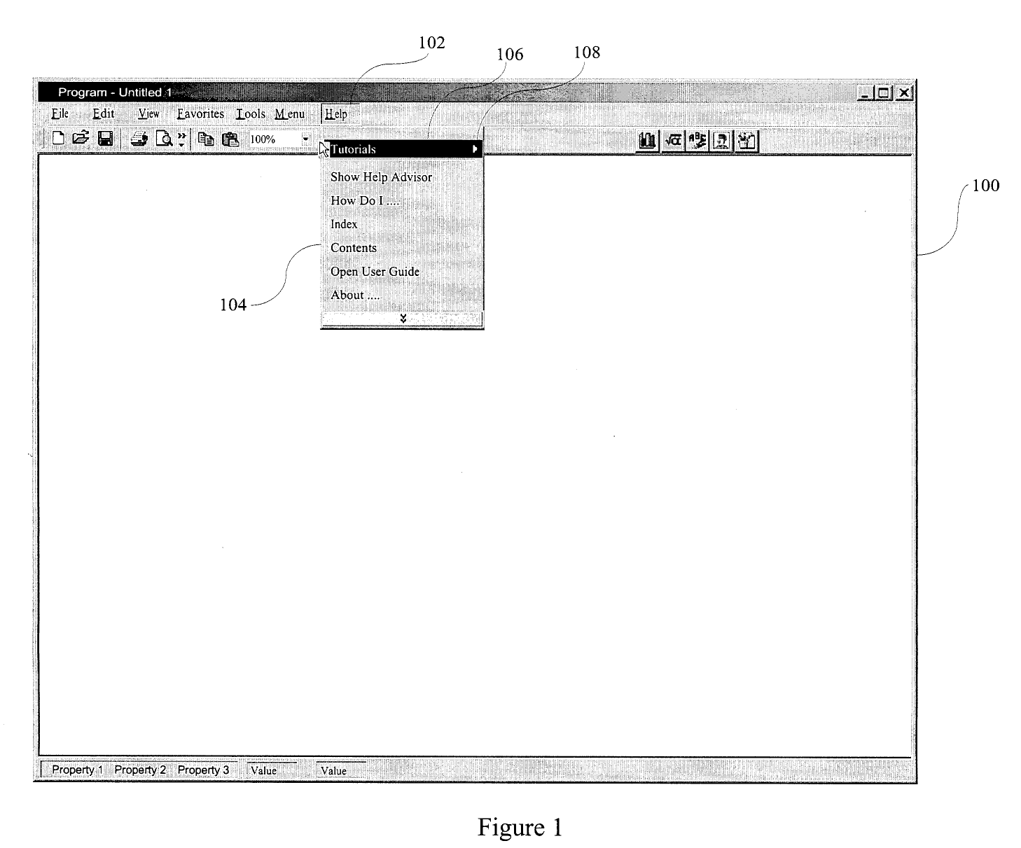

At step 410, a determination is made as to whether or not the menu selection made by the user invokes a cascading menu (i.e., is the selected menu item a cascading menu item?). In the example illustrated in FIGS. 1-3 of the present invention, the selection “tutorials” is a cascading menu item, i.e., it invokes a cascading menu, as indicated by the right arrow 108 in the figures, while the remaining displayed menu selections do not invoke a cascading menu. If, at step 410, it is determined that the menu selection does not invoke a cascading menu, then the process proceeds to step 412, where the operation associated with the menu selection is performed in the usual manner.

If at step 410, it is determined that the menu selection does invoke a cascading menu, then at step 414, the GUI identifies the default cursor position or the cursor position selected by the user for use with cascading menus, and then the cursor is automatically moved to the identified position. Thus, for example, if the default or user selected position as “top left”, then the mouse cursor would be automatically moved to approximately the position shown in FIG. 3, that is, to the top left of the child menu 210.

At step 416, the user selects a selection from the displayed cascading menu in the known manner, i.e., by highlighting the selection with the mouse pointer. The process then proceeds back to step 410 to determine if this menu selection invokes an additional cascading menu. As is well known, cascading menus can cascade down an essentially unlimited number of levels. If, at step 410, it is determined that an additional cascading menu is invoked based upon the menu selection, the process proceeds to step 414 and step 416. If, however, at step 410, it is determined that the menu selection does not invoke a cascading menu, the process proceeds to step 412 and the process terminates at step 418.

It will be understood that each element of the illustrations, and combinations of elements in the illustrations, can be implemented by general and/or special purpose hardware-based systems that perform the specified functions or steps, or by combinations of general and/or special-purpose hardware and computer instructions. The programming required to configure a GUI or any other software to perform the described functions is well within the capabilities of a programmer of ordinary skill in the art given the direction set forth above and shown in the drawings.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-4 support combinations of means for performing the specified functions, combinations of steps for performing the specified functions, and program instruction means for performing the specified functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation on which the GUI or other application is stored. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

While there has been described herein the principles of the invention, it is to be understood by those skilled in the art that this description is made only by way of example and not as a limitation to the scope of the invention. For example, although the above description is focused on the use of the present invention with a GUI installed on a PC, it is understood that it can function in any user interface in which a window display invokes an additional window display, including applications in PDA's, cell phones, and the like. In addition, while the above description focuses on automatic movement of the mouse pointer towards a cascading menu, it is understood that the present invention also contemplates the movement of the mouse pointer to any location on the viewing surface. It is intended by the appended claims, to cover all modifications of the invention which fall within the true spirit and scope of the invention.

1. In a computer program, a method of reducing the amount of mouse movement required to access menu selections from a cascading menu invoked by selection of a cascading menu item in a parent menu using a mouse pointer at a designation point in said parent menu, comprising the step of:
automatically positioning the mouse pointer to a location closer to said cascading menu than said designation point upon selection of said cascading menu item.

2. The method of claim 1, wherein said automatic positioning step comprises at least the step of automatically positioning the mouse pointer to a location between said designation point and said cascading menu.

3. The method of claim 1, wherein said automatic positioning step comprises at least the step of automatically positioning the mouse pointer to a location within said cascading menu.

4. The method of claim 1, further comprising the steps of:
presenting to a user of said computer program a selection mechanism enabling selection of the location where the mouse pointer will be automatically positioned; and
automatically positioning the mouse pointer at the selected location upon selection of said cascading menu item.

5. The method of claim 1, wherein said computer program comprises a Graphical User Interface.

6. A Graphical User Interface (GUI), comprising:
determining means for determining if a cascading menu item has been selected from a parent menu of said GUI;
repositioning means for automatically repositioning a mouse pointer from a designation point in said parent menu to a location closer to a cascading menu displayed upon selection of said cascading menu item.

7. The GUI of claim 6, further comprising:
selection means for enabling a user of said GUI to select the location for automatic repositioning of said mouse pointer.

8. The GUI of claim 6, wherein said selection means comprises a drop down menu of locations selectable by the user.

9. The GUI of claim 6, wherein said selection means comprises a dialogue input window in which the user can input a location value to select the repositioning location of said mouse pointer.

10. A system for reducing, in a computer program, the amount of mouse movement required to access menu selections from a cascading menu invoked by selection of a cascading menu item in a parent menu using a mouse pointer at a designation point in said parent menu, comprising:
means for automatically positioning the mouse pointer to a location closer to said cascading menu than said designation point upon selection of said cascading menu item.

11. The system of claim 10, wherein said means for automatic positioning comprises means for automatically positioning the mouse pointer to a location between said designation point and said cascading menu.

12. The system of claim 10, wherein said means for automatic positioning comprises means for automatically positioning the mouse pointer to a location within said cascading menu.

13. The system of claim 10, further comprising:
means for presenting to a user of said computer program a selection mechanism enabling selection of the location where the mouse pointer will be automatically positioned; and
means for automatically positioning the mouse pointer at the selected location upon selection of said cascading menu item.

14. The system of claim 10, wherein said computer program comprises a Graphical User Interface.

15. A computer program product recorded on computer readable medium for reducing the amount of mouse movement required to access menu selections from a cascading menu invoked by selection of a cascading menu item in a parent menu of a computer program using a mouse pointer at a designation point in said parent menu, comprising:
computer readable means for automatically positioning the mouse pointer to a location closer to said cascading menu than said designation point upon selection of said cascading menu item.

16. The computer program product of claim 15, further comprising computer readable means for automatically positioning the mouse pointer to a location between said designation point and said cascading menu.

17. The computer program product of claim 15, further comprising computer readable means for automatically positioning the mouse pointer to a location within said cascading menu.

18. The computer program product of claim 15, further comprising:
computer readable means for presenting to a user of said computer program a selection mechanism enabling selection of the location where the mouse pointer will be automatically positioned; and
computer readable means for automatically positioning the mouse pointer at the selected location upon selection of said cascading menu item.

19. The computer program product of claim 15, wherein said computer program comprises a Graphical User Interface.
